(19) United States
(12) Patent Application Publication
(10) Pub. No.: US 2016/0178070 A1
(43) Pub. Date: Jun. 23, 2016

(54) PLUG VALVE SEAL

(71) Applicants: Timothy H. Rushton, Farr West, UT (US); Danny K. Zitting, St. George, UT (US); A. Todd Hagen, Murray, UT (US)

(72) Inventors: Timothy H. Rushton, Farr West, UT (US); Danny K. Zitting, St. George, UT (US); A. Todd Hagen, Murray, UT (US)

(73) Assignee: AKTIEBOLAGET SKF, GOTEBORG (SE)

(21) Appl. No.: 14/974,597

(22) Filed: Dec. 18, 2015

Related U.S. Application Data
(60) Provisional application No. 62/093,723, filed on Dec. 18, 2014.

(51) Int. Cl. F16K 5/04; F16J 15/3268; F16J 15/328; F16J 15/3252

(52) U.S. Cl. CPC F16K 5/0464; F16J 15/3252; F16J 15/3268; F16J 15/328

(57) ABSTRACT

A seal for a plug valve and method for manufacturing a seal. The seal includes a sealing element, and a back-up ring coupled with the sealing element by an interference fit. When the back-up ring and the sealing element are coupled together, the back-up ring and the sealing element are curved about a first axis and about a second axis.

### BACKGROUND

Plug valves generally have a cylindrical body with a bore formed longitudinally therein, an inlet at one axial end of the cylindrical body that communicates with the bore, and an outlet that extends laterally through the sidewall and communicates with the bore. Further, plug valves generally employ a plug disposed within the bore, which may be moved (e.g., rotated) to selectively block or allow fluid communication from the inlet to the outlet via the bore.

A connection with an external pipe or another fluid conduit is formed at the outlet port, so that fluid may be transported to locations downstream when the valve is opened. This connection may be sealed with a face seal, often provided by an O-ring received into a groove formed on the outer surface of the cylindrical body of the plug valve, around the outlet.

However, because the outlet port is formed on a circumferential surface, e.g., the side of the cylindrical body, forming a reliable seal can prove challenging using standard O-rings. O-rings generally have a toroidal shape, whereas the groove is curved around the cylindrical surface. Thus, to maintain the O-rings in a groove formed on the circumferential surface of the valve body, heavy grease is used to maintain the O-rings in a bent position in the groove. However, the O-rings may still tend to resiliently recoil out of the groove, which may make assembly more difficult.

Further, such O-rings are typically made of a relatively soft material, such as rubber, to create the fluid-tight seal. In high-pressure situations, however, such soft O-rings may extrude outwards, e.g., be deformed so as to migrate between the two metal surfaces. This extrusion may result in the seal failing, and thus the connection between the valve outlet and the conduit leaking

### SUMMARY

Embodiments of the disclosure may include a seal for a plug valve. The seal includes a sealing element and a back-up ring coupled with the sealing element by an interference fit. When the back-up ring and the sealing element are coupled together, the back-up ring and the sealing element are curved about a first axis and about a second axis.

Embodiments of the disclosure may provide a method for manufacturing a seal. The method includes obtaining a back-up ring and a sealing element. The sealing element and the back-up ring are curved about a first axis, and at least the back-up ring is curved about a second axis. The method also includes coupling the back-up ring together with the sealing element. A combination of the back-up ring and the sealing element is curved about the first axis and the second axis. The method further includes receiving the combination of the back-up ring and the sealing element in a groove formed in a circumferential surface.

These and other aspects of the disclosure will be described in greater detail below. Accordingly, it will be appreciated that the foregoing summary is intended merely to introduce a subset of the aspects described below and is, therefore, not to be considered limiting on the present disclosure.

### BRIEF DESCRIPTION OF THE DRAWINGS

The accompanying drawings, which are incorporated in and constitutes a part of this specification, illustrate an embodiment of the present teachings and together with the description, serve to explain the principles of the present teachings. In the figures:

FIG. 1 illustrates an exploded, cross-sectional view of a seal and a groove in a cylindrical surface, according to an embodiment.

FIG. 2 illustrates a partial, sectional view of the seal, according to an embodiment.

FIG. 3 illustrates a raised, perspective view of the seal, according to an embodiment.

FIG. 4 illustrates a raised, perspective view of a groove formed in a cylindrical surface of a plug valve, according to an embodiment.

FIG. 5 is a flow diagram illustrating a method of manufacturing a seal, according to an embodiment.

It should be noted that some details of the figure have been simplified and are drawn to facilitate understanding of the embodiments rather than to maintain strict structural accuracy, detail, and scale.

### DETAILED DESCRIPTION

Reference will now be made in detail to embodiments of the present teachings, examples of which are illustrated in the accompanying drawing. In the drawings, like reference numerals have been used throughout to designate identical elements, where convenient. In the following description, reference is made to the accompanying drawings that form a part of the description, and in which is shown by way of illustration one or more specific example embodiments in which the present teachings may be practiced.

Further, notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

Additionally, when referring to a position or direction in a well, the terms “above,” “up,” “upward,” “ascend,” and various grammatical equivalents thereof may be used to refer to a position in a well that is closer to the surface than another position, or a movement or direction proceeding toward the surface (topside), without regard as to whether the well is vertical, deviated, or horizontal. Similarly, when referring to a position in a well, the terms “below,” “down,” “downward,” and “descend” and various grammatical equivalents thereof may be used to refer to a position in a well that is farther from the surface than another position, or a direction or movement proceeding away from the surface, regardless of whether the well is vertical, deviated, or horizontal. Moreover, the terms “upper,” “lower,” “above,” and “below,” when referring to components of an apparatus, are used to conveniently refer to the relative positioning of components or elements, e.g., as illustrated in the drawings, and may not refer to any particular frame of reference. Thus, a component may be flipped or viewed in any direction, while parts thereof may remain unchanged in terms of being “upper” or “lower” etc.

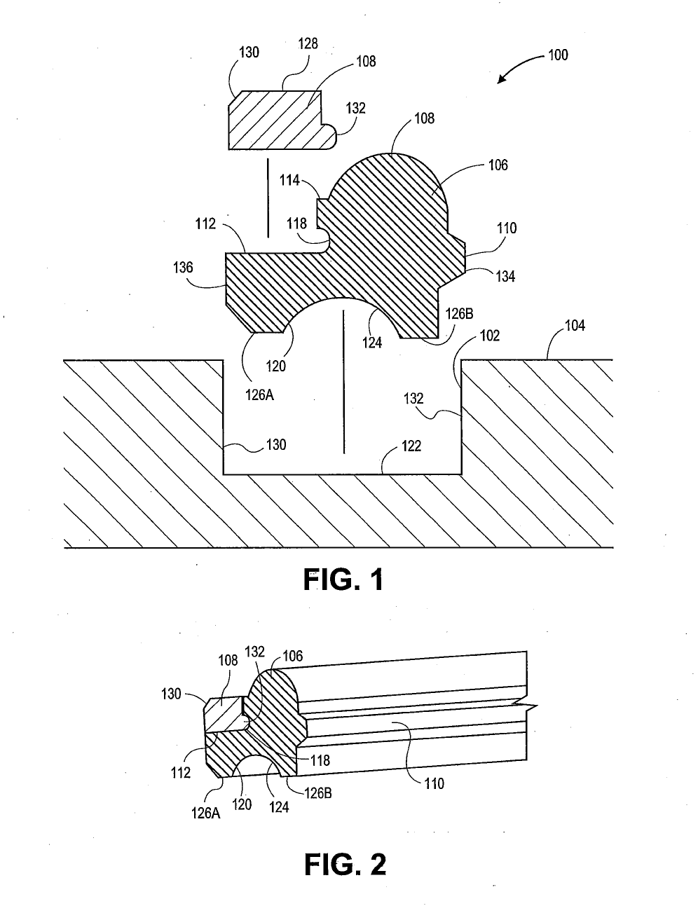

FIG. 1 illustrates an exploded, cross-sectional view of a seal 100 being received into a groove 102, according to an embodiment. The groove 102 may be defined in a wall 104, which may, for example, be a cylindrical body of a plug valve. In other embodiments, the groove 102 may be formed in any circumferential (e.g., curved) surface, whether part of a plug valve, another type of valve, or any other type of component for which a sealed connection may be formed.

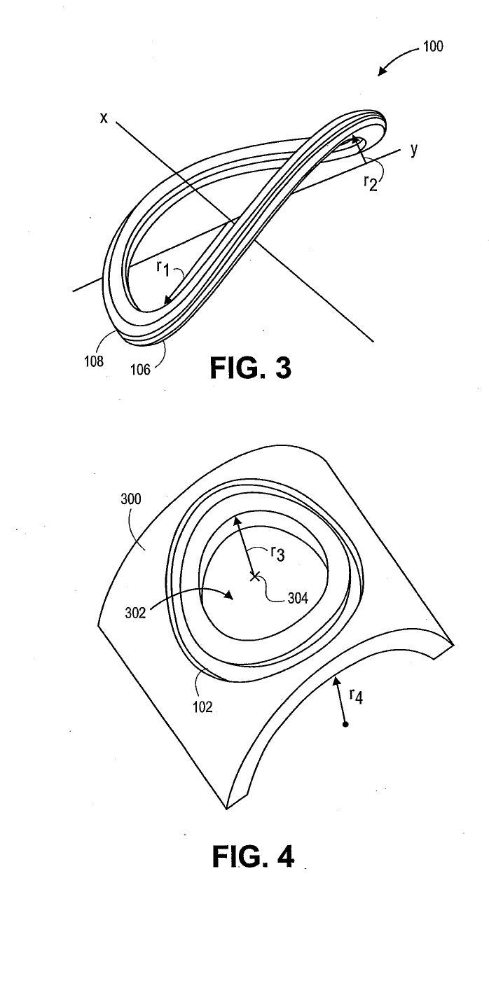

FIG. 2 illustrates a partial sectional view of the seal 100, according to an embodiment. Referring now to both FIGS. 1 and 2, the seal 100 may include a sealing element 106 and a back-up ring 108. In some embodiments, the back-up ring 108 may be made from a material having a first hardness, and the sealing element 106 may be made from a material having a second hardness, with the first hardness being greater than the second hardness. Stated otherwise, the sealing element 106 may be made from a softer material than the back-up ring 108. For example, the sealing element 106 may be made at least partially from an elastomer, such as rubber, or any other material that is capable of forming a face seal between two hard (e.g., metal) elements and is suitable for use with any fluids with which the sealing element 106 may come into contact. The back-up ring 108 may be formed from a polymer such as nylon, a metal or metal alloy, a composite material, or any other suitable material.

The back-up ring 108 and the sealing element 106 may be formed in a single mold, i.e., molded together, such that the two are coupled together as part of the forming process. In another embodiment, the back-up ring 108 and the sealing element 106 may be separately formed, and thereafter coupled together, as will be described below.

The sealing element 106 may be generally annular in shape. As shown in the illustrated cross-section, the sealing element 106 may include a rounded outer sealing surface 108, which may be configured to contact and form a seal with a conduit, or another structure, received downwardly onto the outer sealing surface 108. The sealing element 106 may also include an inner rib 110, which may extend along at least a portion (e.g., all) of an inner diameter of the sealing element 106. The sealing element 106 may also include a shoulder 112 that is formed on the outer diameter side of the sealing element 106, e.g., extending to or toward the outer diameter of the sealing element 106. The shoulder 112 may extend along at least a portion (e.g., along all) of the outer diameter of the sealing element 106.

The sealing element 106 may further include an overhanging lip 114, which may be spaced apart from the shoulder 112 by a retaining recess 118. The sealing element may also include a bottom surface 120, which may be opposite to the rounded sealing surface 108, and may be configured to seal with a bottom 122 of the groove 102. The bottom surface 120 may define a rounded cut-away 124 disposed between two legs 126A, 126B.

The back-up ring 108 may include a main portion 128, which may be generally rectangular in cross-section, although it may include a beveled corner 130, as shown. The back-up ring 108 may also include a retaining rib 132, which may extend inwards, e.g., along an inner diameter of at least a portion (e.g., along all of the inner diameter) of the back-up ring 108. The retaining rib 132 may be sized to fit into the retaining recess 118. In some embodiments, the retaining rib 132, specifically any portion thereof configured to fit into the retaining recess 118, may be slightly larger in cross-sectional area than the retaining recess 118.

In an embodiment, the back-up ring 108 may be coupled with the sealing element 108. For example, as shown, the back-up ring 108 may be received onto the shoulder 112 of the sealing element 106, e.g., on the outer-diameter side of the sealing surface 108. Further, the retaining rib 132 being larger in cross-sectional area than the retaining recess 118 may result in the sealing element 106 snapping onto the back-up ring 108. In particular, for example, the overhanging lip 114 may be elastically deformed by interaction with the retaining rib 132, thereby forming an interference fit between the back-up ring 108 and the sealing element 106, which may tend to retain the sealing element 106 in connection with the back-up ring 108.

The sealing element 106 and the back-up ring 108 may be received into the groove 102. For example, at least a portion of the bottom surface 120, e.g., the legs 126A, 126B may contact the bottom 122 of the groove 102, so as to seal therewith. Further, the rib 110 and the shoulder 112 may contact sidewalls 130, 132 of the groove 102. In an embodiment, the width of the cross-section of the sealing element 106 (from the inner surface 134 of the rib 110 to the outer surface 136 of the shoulder 112) may be larger than the distance between the sidewalls 130, 132 of the groove 102. Accordingly, by application of force, e.g., on the sealing surface 106, the shoulder 112, and/or the back-up ring 108, toward the groove 102, the resilient sealing element 106 may be squeezed radially, thereby providing an interference fit between the sealing element 106 and the wall 104 forming the groove 102.

In some embodiments, the squeezing the sealing element 106 radially may result in the rib 110 being deflected. In some embodiments, the back-up ring 108 may prevent the shoulder 112 from deflecting by interaction with the wall 130. Further, the back-up ring 108 may serve to prevent the sealing surface 108 from deforming outwards (e.g., extruding) to a damaging degree in a radial-outward direction upon application of a pressure differential across the seal 100.

FIG. 3 illustrates a perspective view of the seal 100, according to an embodiment. FIG. 4 illustrates a perspective view of a circumferential surface 200, e.g., of a plug valve, in which the groove 102 is defined, according to an embodiment. Referring to both FIGS. 3 and 4, it may be seen that the seal 100, e.g., once the back-up ring 108 is coupled with the sealing element 106, may be shaped to fit into groove 102 formed in the circumferential surface 104.

In particular, the seal 100 may have a bent torus or “potato chip” shape, which may be suited for receiving into the groove 102. For example, the seal 100 may be curved about two axes. The first axis X may be the longitudinal axis of the seal 100, which may be aligned with the center 304 of a port 302 of the circumferential surface 200. The second axis Y may be a diametral line, e.g., perpendicular to the first axis X, and may extend radially between what would be two points of the annular sealing element 100, but for the curve defined around the second axis Y.

Thus, the seal 100 may be formed (curved) generally uniformly around the first axis X, so as to form a generally annular (toroidal) shape, and the seal 100 may be curved partially about the second axis Y to form the bend in the torus. The radius of curvature r₁ about the first axis X may be generally equal to the radius of curvature r₃ of the groove 102 about the center 304. The radius of curvature r₂ about the second axis Y may be approximately equal to the radius of curvature r₃ of the circumferential surface 200, which may define the curvature of the bottom 122 (FIG. 1) of the groove 102, which may be curved along with the circumferential surface 300. As such, the seal 100 may be received into the groove 102, e.g., employing one or more interference fits as described above (and/or others), and may be shaped such that, unlike a flat O-ring (in some embodiments), the seal 100 either is shaped so as to not recoil out of the groove 102, or is internally prevented from recoiling out of the groove 102, as will be described in greater detail below.

Referring again to FIGS. 1 and 2, in some embodiments, both the back-up ring 108 and the sealing element 106 may be formed having the bent-torus shape. As such, the back-up ring 108 may be snapped into (or otherwise coupled with) the sealing element 106, so as to form the seal 100. In another embodiment, the sealing element 106 may have a generally flat shape, e.g., may be initially curved about the first axis X (forming the torus), but not “naturally” (i.e., without application of an external bending force) substantially curved about the second axis Y. The back-up ring 108, which may have a greater rigidity with respect to the sealing element 106 may have the bent torus shape. Once fitted together, the sealing element 106 may comply (e.g., resiliently) with the shape of the back-up ring 108, and thus the seal 100 may take on the bent torus shape, and may then be received into the groove 102.

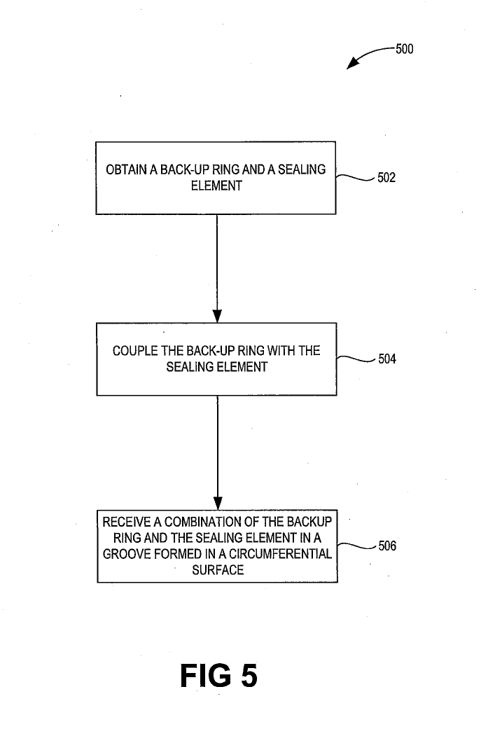

FIG. 5 illustrates a method 500 for manufacturing a seal, e.g., for a plug valve, according to an embodiment. The method 500 may result in the formation of one or more embodiments of the seal 100 discussed above, and may thus be best understood with reference thereto; however, one or more embodiments of the method 500 may not be limited to any particular structure.

The method 500 may include obtaining a back-up ring and a sealing element, as at 502. In an embodiment, the sealing element and the back-up ring are curved about a first axis, and at least the back-up ring is curved about a second axis. In an embodiment, the back-up ring and the sealing element may be formed in the same mold. In another embodiment, the back-up ring and the sealing element may be separately formed.

The method 500 may also include coupling the back-up ring with the sealing element, as at 504. In embodiments where the back-up ring is molded with the sealing element, such coupling may be simultaneous with obtaining the back-up ring and sealing element. In embodiments where the back-up ring is formed separately from the sealing element, coupling at 504 may occur after obtaining at 502.

A combination of the back-up ring and the sealing element (e.g., after coupling the two together) may be curved about the first axis and the second axis. In an embodiment, coupling the back-up ring together with the sealing element includes bending the sealing element about the second axis. In such an embodiment, the sealing element may not be naturally bent about the second axis prior to coupling with the back-up ring.

In an embodiment, coupling together the back-up ring and the sealing element may include forming an interference fit between the back-up ring and the sealing element. For example, forming the interference fit may include receiving the back-up ring onto a shoulder formed on an outer diameter side of the sealing element, and receiving a retention rib of the back-up ring into a retention recess of the sealing element. The retention recess may be formed between the shoulder and an overhanging lip of the sealing element. Further, receiving the retention rib of the back-up ring into the retention recess may include elastically deflecting the overhanging lip by interaction with the retention rib. In an embodiment, the retention rib has a first cross-sectional area and the retention recess has a second cross-sectional area, the first cross-sectional area being greater than the second cross-sectional area such that receiving the retention rib into the retention recess causes the overhanging lip to deflect.

The method 500 may further include receiving the combination of the back-up ring and the sealing element in a groove formed in a circumferential surface, as at 506. In an embodiment, receiving the combination of the back-up ring and the sealing element in the groove comprises forming an interference fit by deflecting a rib of the sealing element by engagement with a sidewall of the groove. In an embodiment, the back-up ring may be configured to prevent the sealing element from extruding radially outwards.

While the present teachings have been illustrated with respect to one or more implementations, alterations and/or modifications may be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A seal for a plug valve, comprising:
a sealing element; and
a back-up ring coupled with the sealing element by an interference fit, wherein, when the back-up ring and the sealing element are coupled together, the back-up ring and the sealing element are curved about a first axis and about a second axis.

2. The seal of claim 1, wherein the first axis is a central longitudinal axis and the second axis is a diametral line, the first and second axes being perpendicular.

3. The seal of claim 1, wherein the sealing element has a first hardness and the back-up ring has a second hardness, the first hardness being less than the second hardness.

4. The seal of claim 1, wherein the sealing element defines a rib on an inner diameter thereof, and wherein the rib is configured to elastically deform when the seal is at least partially received into a groove.

5. The seal of claim 4, wherein the sealing element defines a shoulder on an outer diameter thereof, and wherein the back-up ring is received onto the shoulder.

6. The seal of claim 5, wherein the back-up ring prevents the shoulder from deflecting when the rib is elastically deformed.

7. The seal of claim 5, wherein the sealing element further comprises an overhanging lip that is separated from the shoulder by a retaining recess, and wherein the back-up ring comprises a retaining rib that is received into the retaining recess.

8. The seal of claim 7, wherein the retaining recess defines a first cross-sectional area and the back-up ring defines a second cross-sectional area, the second cross-sectional area being larger than the first cross-sectional area.

9. The seal of claim 1, wherein the sealing element comprises a rounded sealing surface and a bottom surface defining a cut-away, and wherein the bottom surface is configured to at least partially seal against a bottom of a groove in which the seal is at least partially received.

10. The seal of claim 1, wherein the back-up ring is curved about the first and second axes, and, wherein, when not coupled with the back-up ring, the sealing element has a generally flat, annular shape, the sealing element being deformed to curve about the second axes when coupled to the back-up ring.

11. The seal of claim 1, wherein the sealing element and the back-up ring are curved about the first and second axes prior to being coupled together.

12. The seal of claim 1, wherein a radius of curvature of the seal about the first axis is approximately equal to a radius of curvature of a groove defined around an outlet formed in a circumferential surface of the plug valve.

13. The seal of claim 12, wherein a radius of curvature about the second axis of the seal is approximately equal to a radius of curvature of the circumferential surface.

14. A method for manufacturing a seal, comprising:
obtaining a back-up ring and a sealing element, wherein the sealing element and the back-up ring are curved about a first axis, and at least the back-up ring is curved about a second axis;
coupling the back-up ring together with the sealing element, wherein a combination of the back-up ring and the sealing element is curved about the second axis; and
receiving the combination of the back-up ring and the sealing element in a groove formed in a circumferential surface.

15. The method of claim 14, wherein coupling the back-up ring together with the sealing element comprises bending the sealing element about the second axis, wherein the sealing element is not naturally bent about the second axis prior to coupling with the back-up ring.

16. The method of claim 14, wherein receiving the combination of the back-up ring and the sealing element in the groove comprises forming an interference fit by deflecting a rib of the sealing element by engagement with a sidewall of the groove.

17. The method of claim 14, wherein coupling together the back-up ring and the sealing element comprises forming an interference fit between the back-up ring and the sealing element.

18. The method of claim 17, wherein forming the interference fit between the back-up ring and the sealing element comprises:
receiving the back-up ring onto a shoulder formed on an outer diameter side of the sealing element; and
receiving a retention rib of the back-up ring into a retention recess of the sealing element, wherein the retention recess is formed between the shoulder and an overhanging lip of the sealing element, and wherein receiving the retention rib of the back-up ring into the retention recess comprises elastically deflecting the overhanging lip by interaction with the retention rib.

19. The method of claim 18, wherein the retention rib has a first cross-sectional area and the retention recess has a second cross-sectional area, the first cross-sectional area being greater than the second cross-sectional area such that receiving the retention rib into the retention recess causes the overhanging lip to deflect.

20. The method of claim 14, wherein obtaining and coupling proceed by forming the back-up ring and the sealing element in a single mold.
